(19) United States
(12) Patent Application Publication
(10) Pub. No.: US 2021/0075931 A1
(43) Pub. Date: Mar. 11, 2021

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: Hidetaka Tabuchi, Kashiwa-shi (JP)

(21) Appl. No.: 17/012,274

(22) Filed: Sep. 4, 2020

(30) Foreign Application Priority Data
Sep. 9, 2019 (JP) 2019-163845

(51) Int. Cl. H04N 1/32; H04N 1/00; G06K 9/00

(52) U.S. Cl. CPC H04N 1/32085; H04N 1/00469; H04N 2201/0094; H04N 1/32096; G06K 9/00268

(57) ABSTRACT

An information processing apparatus comprises an obtaining unit that obtains image data; an extracting unit that extracts a feature amount of a predetermined object included in the image data; a determining unit that, based on the feature amount extracted by the extracting unit, determines whether a specific object is included in an image expressed by the image data; and a destination setting unit that, in a case where the determining unit has determined that the specific object is included in the image expressed by the image data, sets, as a transmission destination of the image data, contact information stored in association with the specific object stored in a storage unit in advance.

### BACKGROUND OF THE INVENTION

### Field of the Invention

The present invention relates to an information processing apparatus capable of using an artificial intelligence function, a control method thereof, and a storage medium.

### Description of the Related Art

Recently, keywords are often being associated with data saved in an information processing apparatus (a process which will be called “tagging” hereinafter) and used to execute searches. For example, some image forming apparatuses, which are a type of information processing apparatus, have a “box” function for reading documents and storing the resulting data in storage in a variety of formats. Japanese Patent Laid-Open No. 2009-32186 discloses a technique in which when data has been stored in a box, tags are added as information associated with the data, folders are created to hold the data, and so on to make it easier to find desired data when searching for that data later on.

However, this conventional technique has the following issue. Although the information added as a tag is mainly used to search for data, using the information added as a tag to saved data can improve the convenience for a user when they use various functions provided by the information processing apparatus. For example, in addition to a printing function for printing images and the above-described box function, image forming apparatuses may have a “send” function, a fax function, or the like for transmitting image data read by the image forming apparatus to the exterior. There is demand, for example, for the ability to set a destination for the send function, the fax function, or the like by using an email address, a telephone number, or the like associated with a human who can be identified from an image included in saved image data. Doing so makes it possible to eliminate the burden of the user manually setting the destination when transmitting image data, which improves the convenience for the user.

### SUMMARY OF THE INVENTION

The present invention enables the realization of a technique in which, when transmitting image data to the exterior, a transmission destination is set in accordance with an image included in the image data.

One aspect of the present invention provides an information processing apparatus comprising: an obtaining unit that obtains image data; an extracting unit that extracts a feature amount of a predetermined object included in the image data; a determining unit that, based on the feature amount extracted by the extracting unit, determines whether a specific object is included in an image expressed by the image data; and a destination setting unit that, in a case where the determining unit has determined that the specific object is included in the image expressed by the image data, sets, as a transmission destination of the image data, contact information stored in association with the specific object stored in a storage unit in advance.

Another aspect of the present invention provides a control method for an information processing apparatus, the method comprising: obtaining image data; extracting a feature amount of a predetermined object included in the image data; determining, based on the feature amount extracted in the extracting, whether a specific object is included in an image expressed by the image data; and in a case where it has been determined in the determining that the specific object is included in the image expressed by the image data, setting, as a transmission destination of the image data, contact information stored in association with the specific object stored in a storage unit in advance.

Still another aspect of the present invention provides a non-transitory computer-readable storage medium storing a program for causing a computer to execute each step of a control method for an information processing apparatus, the method comprising: obtaining image data; extracting a feature amount of a predetermined object included in the image data; determining, based on the feature amount extracted in the extracting, whether a specific object is included in an image expressed by the image data; and in a case where it has been determined in the determining that the specific object is included in the image expressed by the image data, setting, as a transmission destination of the image data, contact information stored in association with the specific object stored in a storage unit in advance.

Further features of the present invention will become apparent from the following description of exemplary embodiments (with reference to the attached drawings).

### BRIEF DESCRIPTION OF THE DRAWINGS

FIG. 1 is a block diagram illustrating an overview of an image forming apparatus 10 according to an embodiment.

FIG. 2 is a diagram illustrating an operating unit 150 according to an embodiment.

FIG. 3 is a block diagram illustrating an overview of a learning processing unit 105 according to an embodiment.

FIG. 4 is a diagram illustrating an example of raster scanning according to an embodiment.

FIG. 5 is a diagram illustrating an example of the tagging of a feature amount and an email address according to an embodiment.

FIG. 6 is an example of a display made in the operating unit 150 while image recognition AI is being used in a send function, according to an embodiment.

FIG. 7 is a diagram illustrating an example of a group photograph which is read, according to an embodiment.

FIG. 8 is an example of a display made in the operating unit 150 when a destination is set automatically in the send function, according to an embodiment.

FIG. 9 is an example of a display made in the operating unit 150 when image recognition AI is not used in the send function, according to an embodiment.

FIG. 10 is an example of a display made in the operating unit 150 for setting a destination when image recognition AI is not used in the send function, according to an embodiment.

FIG. 11 is a flowchart illustrating the setting of contact information when reading an image, according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

Note that a multifunction peripheral (digital multifunction peripheral; MFP), which is an image forming apparatus, will be described as an example of an information processing apparatus according to the embodiment. However, the applicable scope is not limited to a multifunction peripheral, and any information processing apparatus which has or can use the artificial intelligence function pertaining to image processing, which will be described below, can be used.

Configuration of Information Processing Apparatus

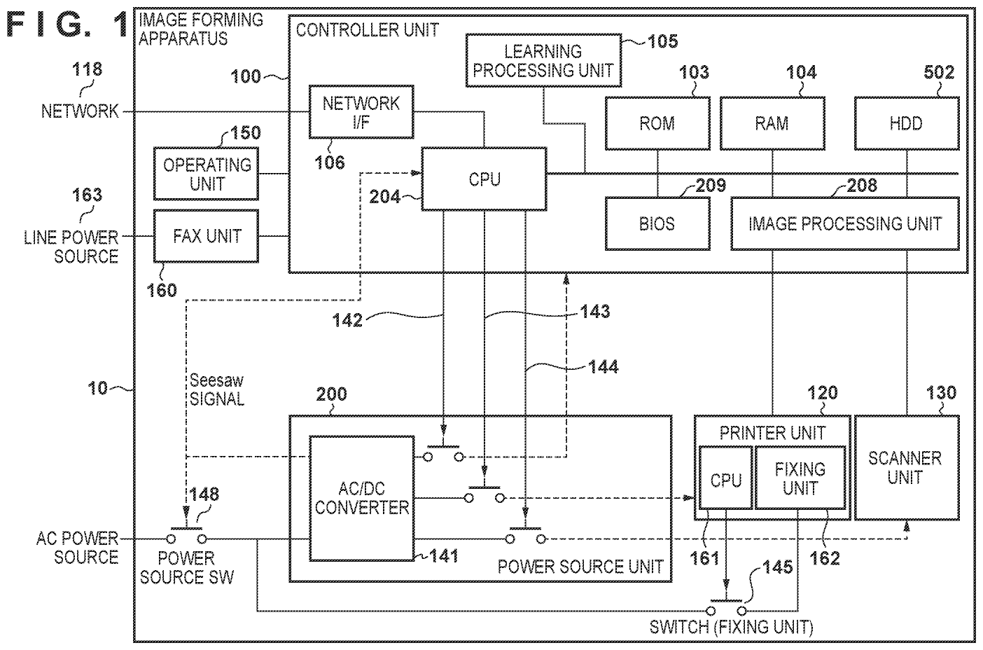

An embodiment of the present invention will be described hereinafter. First, an example of the configuration of an image forming apparatus 10, serving as the information processing apparatus according to the present embodiment, will be described with reference to FIG. 1. The image forming apparatus 10 is a multifunction peripheral (MFP) provided with a plurality of functions, such as a print function, a scanner function, a copy function, and a fax function.

The image forming apparatus 10 includes an operating unit 150, a fax unit 160, a controller unit 100, a printer unit 120, a scanner unit 130, a power source unit 200, switches 142 to 145, and a power source switch 148. The controller unit 100, which is a CPU system, includes a CPU 204, ROM 103, RAM 104, an HDD 502, a network interface 106, and a BIOS 209.

The CPU 204 executes software programs stored in the RAM 104, the HDD 502, and the like, and controls the apparatus as a whole. The ROM 103 stores, for example, a startup program for the controller unit 100, programs and fixed parameters used when executing image processing, and so on. The RAM 104 is used to store programs, temporary data, and the like when the CPU 204 controls the image forming apparatus 10. Note that the programs, the temporary data, and the like stored in the RAM 104 are read out from the ROM 103, the HDD 502 (described below), or the like. The HDD 502 serves as main storage for storing programs executed by the CPU 204, program management tables, various types of data, and so on. The executed programs are, for example, boot programs executed by the CPU 204 in order to launch an OS when the information processing apparatus is started up (a boot loader 302 and a kernel 301). Although an HDD is described as being used as the storage here, an SSD, eMMC, NAND flash memory, NOR flash memory, or the like may be used instead.

The network interface 106 is connected to a network 118, and transmits and receives data to and from one or more external apparatuses which can be communicated with over the network 118. Specifically, the network interface 106 receives data sent over the network 118, transmits image data read by the scanner unit 130, data saved in the HDD 502, and the like to prescribed destinations over the network 118, and soon. The power source unit 200 supplies power to the image forming apparatus 10. When the power is off, an AC power source is insulated by the power source switch 148, and when the power source switch 148 is turned on, AC power is supplied to an AC-DC converter 141 to create a DC power source.

The AC power source (a power source device) can control three independent power systems of the overall apparatus in response to instructions from the CPU 204. The supply of power to the controller unit 100 can be controlled by a switch 142. The supply of power to the printer unit 120 can be controlled by a switch 143. The supply of power to the scanner unit 130 can be controlled by a switch 144.

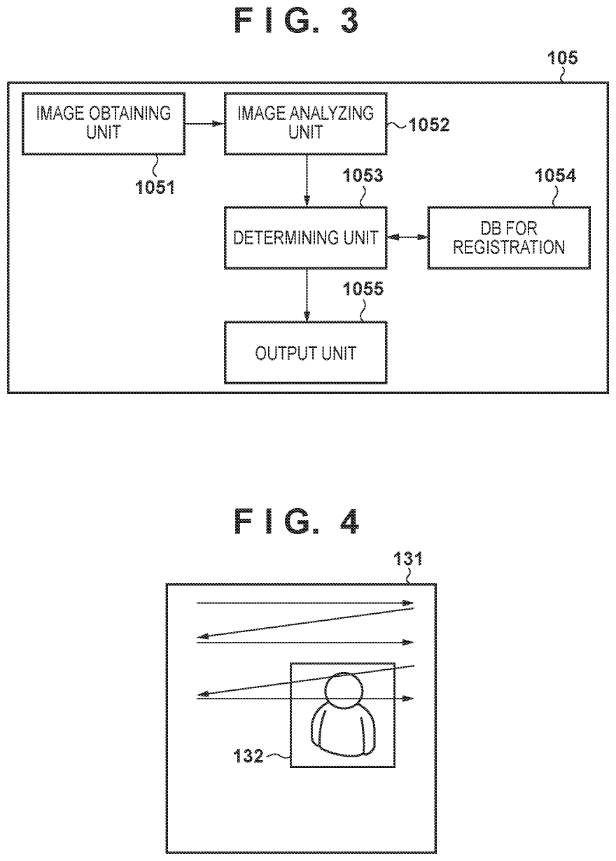

A learning processing unit 105 carries out deep learning on images read by the scanner unit 130. Although the learning processing unit 105 is provided in the image forming apparatus 10 in the present embodiment, the configuration may be such that a learning server is provided outside the image forming apparatus 10 and used by being connected over a network. The functions of the learning processing unit 105 will be described in detail later with reference to FIG. 3.

The scanner unit 130 is an example of a reading unit that reads a document and generates black-and-white image data, color image data, and the like. The scanner unit 130 is connected to the CPU 204 by a scanner control interface (not shown). The CPU 204 controls image signals input from the scanner unit 130 via the scanner control interface.

The printer unit 120 prints image data converted from PDL data accepted by the network interface 106, image data generated by the scanner unit 130, and the like onto paper (a sheet). The printer unit 120 includes a CPU 161 and a fixing unit 162, for example. The fixing unit 162 uses heat and pressure to fuse a toner image, which has been transferred to the paper, onto the paper. In FIG. 1, power is supplied to the fixing unit 162 from the AC power source via a switch 145, and the heat is produced by the supply of power. Note that the power may be supplied via the AC-DC converter 141. The CPU 161 functions as a printer controller, using the RAM 104. Power is supplied to the CPU 161 via the AC-DC converter 141, and the supply of power to the fixing unit 162 is controlled by the switch 145.

The power source switch 148 switches between supplying power and not supplying power to the image forming apparatus 10 by switching on and off. Whether the switch is on or off is determined based on a seesaw signal connected between the power source switch 148 and the CPU 204. When the seesaw signal is high, the power source switch 148 is on, whereas when the seesaw signal is low, the power source switch 148 is off.

The BIOS 209 is non-volatile memory storing a boot program (a BIOS). An image processing unit 208 is connected to the CPU 204, the printer unit 120, and the scanner unit 130. The image processing unit 208 performs image processing such as color space conversion on a digital image output from the scanner unit 130, and outputs the post-image processing data to the CPU 204. The image processing unit 208 also performs image processing such as color space conversion based on image data read by the scanner unit 130, converts the image data into bitmap data, and outputs the bitmap data to the printer unit 120.

The fax unit 160 can transmit and receive digital images to and from a telephone line or the like. In addition to the copy function, the image forming apparatus 10 can save data read by the scanner unit 130 in the HDD 502, execute a send function, a fax function, and so on for transmitting data to the network 118 or a fax line, and the like. With the copy function, data read by the scanner unit 130, image data received from an external apparatus such as a PC (not shown) connected over the network 118, image data received by the fax unit 160, and the like can be printed. With a save function of the image forming apparatus 10, data read by the scanner unit 130 is saved in the HDD 502. The saved data can be printed using the copy function, transmitted, using the send function or the fax function (described below), to an external apparatus connected over the network 118, and so on. The send function is a function for transmitting image data saved in the HDD 502, data read by the scanner unit 130, and so on over the network 118 to a designated destination. This will be described in greater detail later. The fax function is a function for transmitting image data saved in the HDD 502, data read by the scanner unit 130, and so on over a fax line.

Operating Unit

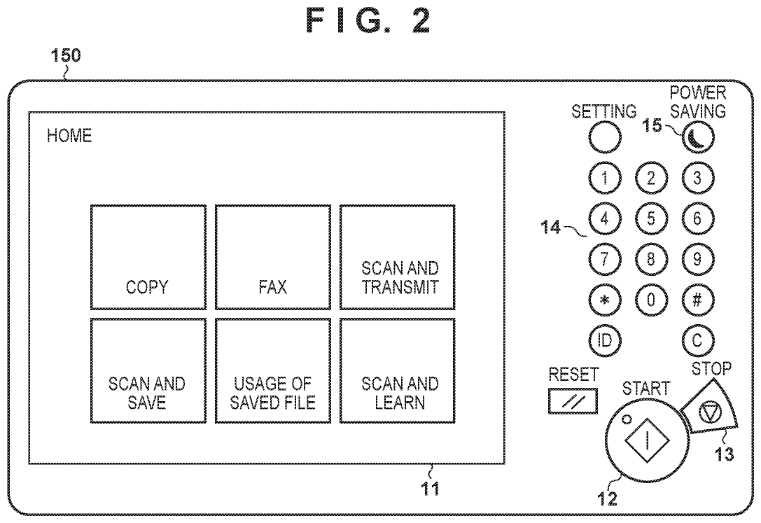

The operating unit 150 according to the present embodiment will be described next with reference to FIG. 2. The operating unit 150 includes a liquid-crystal operating panel 11, a start key 12, a stop key 13, a physical key group 14, and a power save key 15.

The liquid-crystal operating panel 11 is a combination of a liquid-crystal display and a touch panel. The liquid-crystal operating panel 11 includes a display unit that displays operating screens, and when displayed keys are operated by a user, information corresponding thereto is sent to the controller unit 100. The start key 12 is used when starting operations for reading and printing a document image, and when instructing other functions to start. Two color LEDs, namely green and red, are incorporated into the start key 12. The green light being lit indicates that operations can start, whereas the red light being lit indicates that operations cannot start. The stop key 13 serves to stop operations which are underway. The physical key group 14 is provided with a numerical keypad, a clear key, a reset key, a guide key, and a user mode key. The power save key 15 is used when transitioning the image forming apparatus 10 from a normal mode, in which all functions can be used, to a sleep mode, in which only the minimum required operations are performed, and when transitioning back to the normal mode. The image forming apparatus 10 transitions to the sleep mode when the user operates the power save key 15 while in the normal mode, and transitions to the normal mode when the user operates the power save key 15 while in the sleep mode. Information required for creating job information, such as a username, a number of copies, and output attribute information, which are input by the user using the liquid-crystal operating panel 11, is transmitted to the controller unit 100.

Learning Processing Unit

The learning processing unit 105 according to the present embodiment will be described in detail next with reference to FIG. 3. The learning processing unit 105 includes an image recognition AI function, is used to set a destination for the send function and the fax function, and is constituted by an image obtaining unit 1051, an image analyzing unit 1052, a determining unit 1053, a registration DB 1054, and an output unit 1055.

The image obtaining unit 1051 passes an image read by the scanner unit 130, image data saved in the HDD 502, or the like to the image analyzing unit 1052 (described below). The image analyzing unit 1052 raster-scans (see FIG. 4) the image data transmitted from the image obtaining unit 1051 and calculates a feature amount (described later). The determining unit 1053 uses an output value found from the feature amount analyzed in a learning phase to set a determination reference for determining whether or not a face (a predetermined object) is present. Furthermore, in an estimation phase, the determining unit 1053 uses machine learning to determine whether or not the face of a specific person registered as determination data in the registration DB 1054 is present in the image data transmitted from the image obtaining unit 1051, based on the feature amount calculated by the image analyzing unit 1052. The specific machine learning method will be described later. Although a human face is given as an example of the predetermined object included in an image expressed by the image data, the present invention is not intended to be limited thereto. The predetermined object may be an image of another object, or may be a text image. For example, a document containing a character string may be read, the name of a human included in the document may be specified, and contact information (a transmission destination) of the specified human may then be set automatically.

The registration DB 1054 stores the feature amount of the image data in association with an email address, a telephone number, or the like as contact information of the individual corresponding to that feature amount. Although the present embodiment describes an example in which this information is stored within the learning processing unit 105, the present invention is not intended to be limited thereto, and the information may be stored in the HDD 502, external memory (not shown), a server, or the like. When the determining unit 1053 has detected the face of an individual registered in the registration DB 1054 in the image data, the output unit 1055 outputs, to the CPU 204, the contact information, such as an email address or a telephone number, associated as a tag with the feature amount of the face of that individual in the registration DB 1054. The CPU 204 then sets that email address or telephone number as a destination. This will be described in greater detail later.

A method used in the learning phase of the machine learning by the learning processing unit 105 will be described next. In the learning phase, the image forming apparatus itself is caused to create a determination standard by training the apparatus on a large number of face and non-face images. The images used for this training may be read by the scanner unit 130, or data saved in the HDD 502 may be used, as well as image data located in an external server. The images used for the training are transmitted to the image analyzing unit 1052 via the image obtaining unit 1051. The image analyzing unit 1052 calculates and analyzes a feature amount valid for facial recognition (e.g., a gradient histogram) for the image data which has been transmitted. The determining unit 1053 uses an output value found from the analyzed feature amount to set the determination reference for determining whether or not the face of an individual is present. Specifically, a face is determined to be present when the output value found from the gradient histogram of the input image data is greater than or equal to a set value.

Facial Recognition

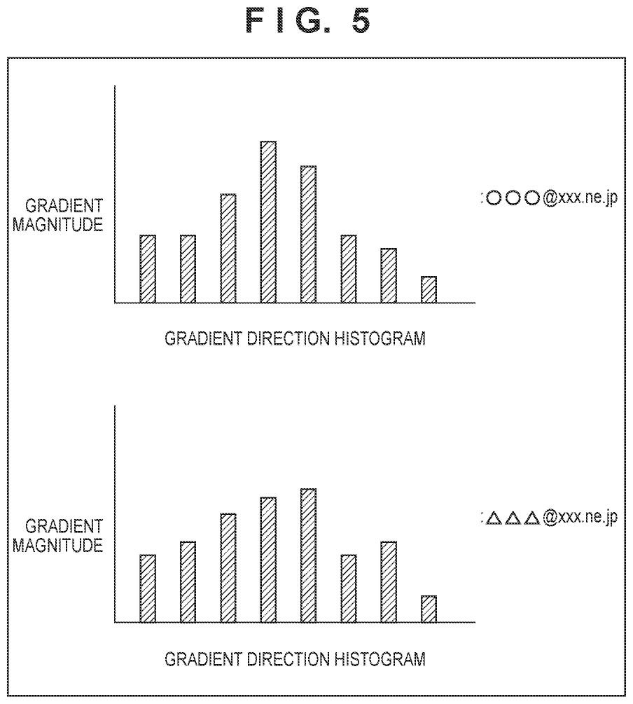

A method for identifying the face of an individual from image data read by the scanner unit 130 and associating contact information of the individual, such as an email address or a telephone number, as a tag with that face, will be described next with reference to FIGS. 3 and 5. First, the image data read by the scanner unit 130 is sent to the image analyzing unit 1052 via the image obtaining unit 1051. The image analyzing unit 1052 calculates a feature amount valid for facial recognition in the image data sent from the image obtaining unit 1051. If an output value calculated from the feature amount is greater than or equal to a determination reference value set for the learning phase, the determining unit 1053 determines that the image is a face image, and stores that feature amount in the registration DB 1054. Although the present embodiment describes an example in which the registration DB 1054 is provided in a storage unit of the image forming apparatus 10, such as the HDD 502, the present invention is not intended to be limited thereto, and the registration DB 1054 may instead be provided in a storage unit of an external apparatus which can be accessed from the image forming apparatus 10, for example. The feature amount of the face of the individual is saved in the registration DB 1054, associated with the contact information, such as the email address or telephone number, of the individual, and that information is then additionally saved in the registration DB 1054 (FIG. 5). FIG. 5 is an image of the information saved in the registration DB 1054. As indicated in FIG. 5, the feature amount (a gradient histogram or the like) and the contact information (an email address) are saved in association with each other for each specified human. Although FIG. 5 illustrates a graph pertaining to the gradient histogram as the feature amount, the data which is actually saved is various types of parameter values expressing that graph. The association of the feature amount with the contact information may be made by the user using the operating unit 150, or the feature amount may be associated with contact information already saved in the HDD 502 of the image forming apparatus 10.

A method used in the estimation phase of the machine learning by the learning processing unit 105 will be described next. First, the image data read by the scanner unit 130 is sent to the image analyzing unit 1052 via the image obtaining unit 1051. The image analyzing unit 1052 calculates a feature amount in the image data sent from the image obtaining unit 1051. The determining unit 1053 compares the calculated feature amount with the feature amounts saved in the registration DB 1054, and if there is an image having a feature amount within a set range, the contact information associated with the feature amount of that individual is output to the output unit 1055. Note that if there are a plurality of images having feature amounts within the set range, the contact information associated with the closest feature amount is output to the output unit 1055.

Send Function Using Image Recognition AI

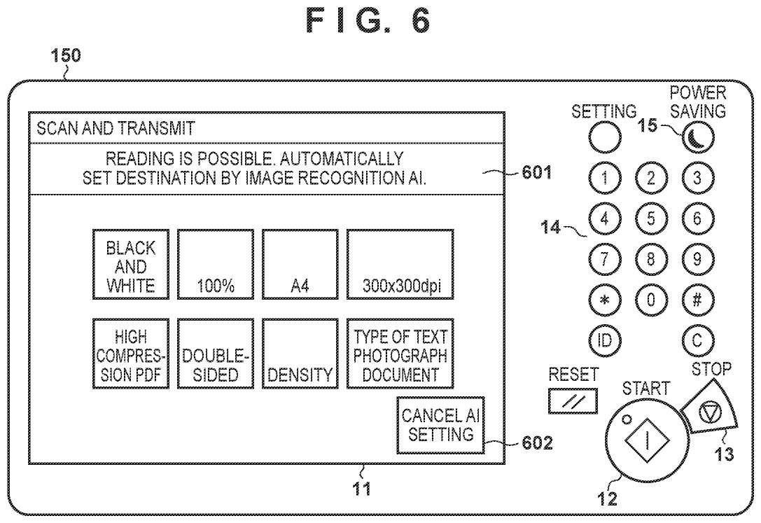

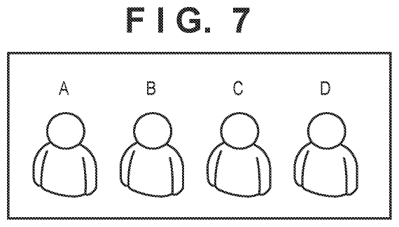

The send function of the image forming apparatus 10 according to the present embodiment, which uses image recognition AI, will be described next with reference to FIGS. 6 to 9, in addition to FIG. 3. The send function is a function for transmitting image data saved in the HDD 502, data read by the scanner unit 130, and so on to a set destination. A transmission destination can be set by the user using the operating unit 150, and can also be set using contact information registered in the HDD 502 in advance. Furthermore, the email address can be set using the image recognition AI function.

When using the send function, the user can set whether or not to use the image recognition AI function. FIG. 6 illustrates an example of a display in the operating unit 150 when the image recognition AI function is used. As indicated by 601, a display indicating “automatic address setting using image recognition AI” is displayed in the liquid-crystal operating panel 11 of the operating unit 150. When image data is read in a state where the image recognition AI is being used, a human on which facial recognition has been performed is specified, and the contact information of the specified human is searched out from the database. Specifically, the human is specified based on the feature amount of the human on which facial recognition has been performed and a feature amount of face data of an individual registered in the registration DB 1054, and the email address associated with that human is set automatically.

A case where a group photograph has been read, as illustrated in FIG. 7, will be described as an example. Four humans, namely person A, person B, person C, and person D, appear in the group photograph illustrated in FIG. 7. Assume here that feature amounts of the faces of person A and person B in the group photograph illustrated in FIG. 7 are registered in the registration DB 1054 in association with email addresses. Upon the image data illustrated in FIG. 7 being read by the scanner unit 130, the image data is first input to the image obtaining unit 1051, and then transmitted to the image analyzing unit 1052. The image analyzing unit 1052 raster-scans the image data transmitted from the image obtaining unit 1051, and the determining unit 1053 then uses machine learning to determine whether or not the face of an individual registered in the registration DB 1054 is present in image data. Specifically, the determining unit 1053 compares the feature amounts of face images registered in the registration DB 1054 with feature amounts in the image data illustrated in FIG. 7. Furthermore, if the result of the comparison indicates that there is a feature amount of the face image which falls within a set range, the determining unit 1053 determines that the face of an individual having that feature amount is present, and the email address registered in the registration DB 1054 is output from the output unit 1055 to the CPU 204. In other words, here, the determining unit 1053 determines whether or not a feature amount similar to the feature amount in the extracted face image (e.g., within a predetermined threshold) is saved in the registration DB 1054.

Here, the feature amounts of the faces of person A and person B, as well as the email addresses associated with those individuals, are registered in the registration DB 1054, and thus the email addresses of person A and person B are output to the CPU 204 from the output unit 1055. The CPU 204 automatically sets the email addresses of person A and person B, which have been output from the output unit 1055, as transmission destinations. When transmitting data, the user may transmit the data using the email addresses which have been automatically set, or may transmit the data after adding, deleting, or otherwise modifying the addresses which have been set.

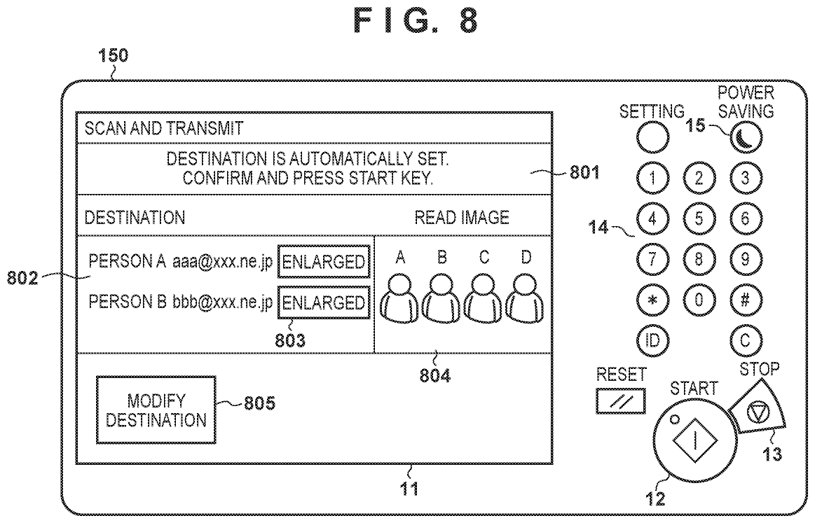

FIG. 8 illustrates a user interface after the contact information has been automatically set using image recognition AI. 801 in the liquid-crystal operating panel 11 displays an indication that the destination has been automatically set. The liquid-crystal operating panel 11 also includes displays indicating a destination 802 which has been automatically set, an enlarge button 803, a read image 804, and a destination modification button 805. The user confirms the destination 802 which has been automatically set with respect to person A and person B, and if there are no problems, the user can commence the transmission by operating the start key 12. Additionally, although the read image 804 is displayed, control may be performed so that by operating the enlarge button 803 which is displayed in an operable manner for each specified human, the human corresponding to the operated enlarge button 803 is displayed in an enlarged manner in the read image 804. This makes it easy for the user to confirm that there are no problems in terms of the specified human and the contact information. Note that a region recognized as a face in the aforementioned facial recognition can be enlarged in the enlarged part. If there is a problem with the destination, the destination can be corrected by operating the destination modification button 805.

The user interface in FIG. 8 illustrates an example in which only the destinations 802 of the specified humans registered in the registration DB 1054 (person A and person B) are displayed. However, the present invention is not limited thereto, and control may be performed so that the other humans subjected to the facial recognition (person C and person D) are also displayed with unknown destinations. In FIG. 8, feature amounts of the faces of person C and person D are not registered in the registration DB 1054, and thus the destinations are not automatically set; however, the determining unit 1053 can determine that faces of individuals are present (facial recognition). Accordingly, after the feature amounts of the individual faces of person C and person D have been registered in the registration DB 1054, those feature amounts may be stored in the registration DB 1054 in association with email addresses input by the user. This makes it possible to automatically set person C and person D as destinations the next and subsequent times face images of person C and person D are read. For example, like the enlarge button 803 illustrated in FIG. 8, register buttons (not shown) may be displayed in an operable manner in fields indicating that the contact information of person C and person D is unknown. In this case, the user can select the register buttons, and input destinations, for person C and person D, whose destinations are unknown; and if the destinations have been set in this manner, it is desirable that the destinations be registered in the registration DB 1054, along with features of the humans subjected to the facial recognition, as training data. The feature amounts of prescribed humans extracted from the document used this time may be added to the registration DB 1054 as training data, even for humans which have been specified (person A and person B). Note that when adding these feature amounts, the feature amounts may be stored as information separate from the feature amounts which are already stored, or may be merged with the feature amounts which are already stored and stored as new feature amounts. It is desirable that this be carried out using an optimal method based on the properties of the feature amounts.

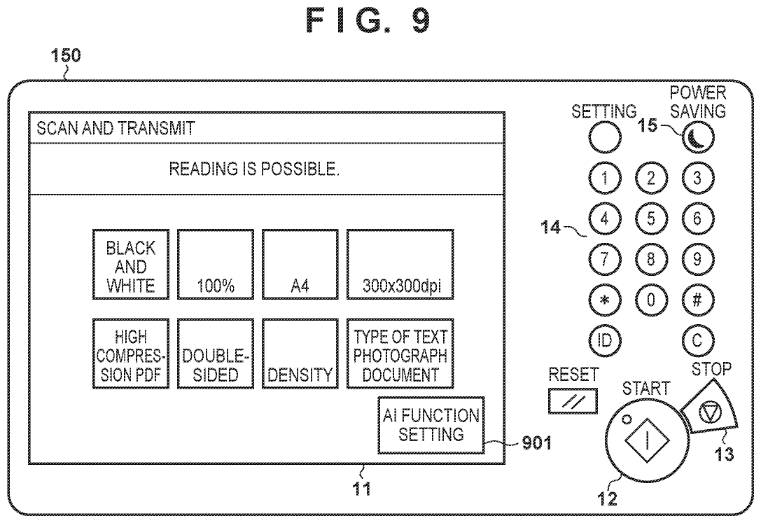

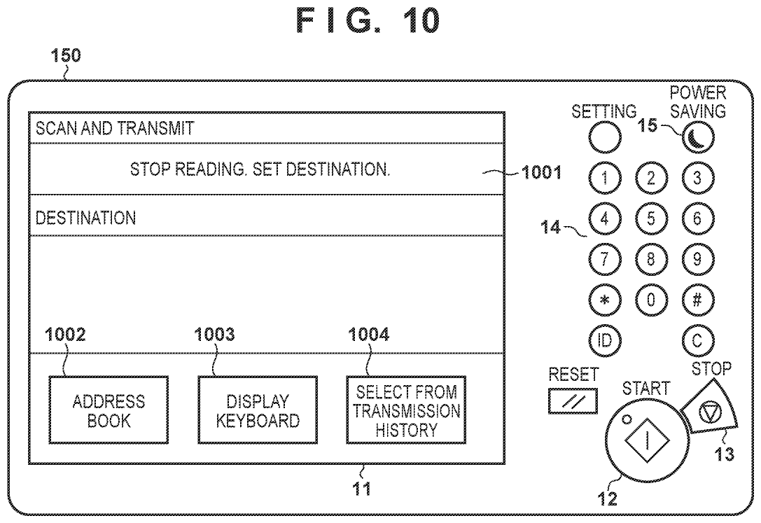

As illustrated in FIG. 6, when the image recognition AI function is being used, a “cancel AI setting” key 602 is displayed in the liquid-crystal operating panel 11 in a selectable manner. When the user operates this key 602, the liquid-crystal operating panel 11 transitions to the display illustrated in FIG. 9, and the image recognition AI function is canceled (deactivated). In this case, after the image data has been read, the liquid-crystal operating panel 11 transitions to a destination setting screen, illustrated in FIG. 10, where the user sets the destination and transmits data him or herself. As illustrated in FIG. 10, buttons 1002 to 1004 are displayed in the liquid-crystal operating panel 11 in a selectable manner. When the button 1002 is selected, an address book is displayed, and an address registered in the address book can be added as a destination. When the button 1003 is selected, contact information can be entered; to be more specific, a keyboard is displayed, and an address can be entered manually. When the button 1004 is selected, a sending history is displayed, and a destination included in the sending history can be selected and added. If the image recognition AI is to be used again, the liquid-crystal operating panel 11 can be transitioned to the display illustrated in FIG. 6, and the image recognition AI can be used (activated), by operating an “AI function setting” key 901 illustrated in FIG. 9. Although the image recognition AI function is turned on or off when using the send function in the present embodiment, the configuration may be such that the image recognition AI function is turned on or off through a user mode setting. Note that the “cancel AI setting” key 602, the “AI function setting” key 901, and the like are examples of a function setting unit.

Note that the operations described above are not limited to the send function, and a similar function can be implemented when using the fax function as well, by employing telephone numbers instead of email addresses.

Processing Sequence

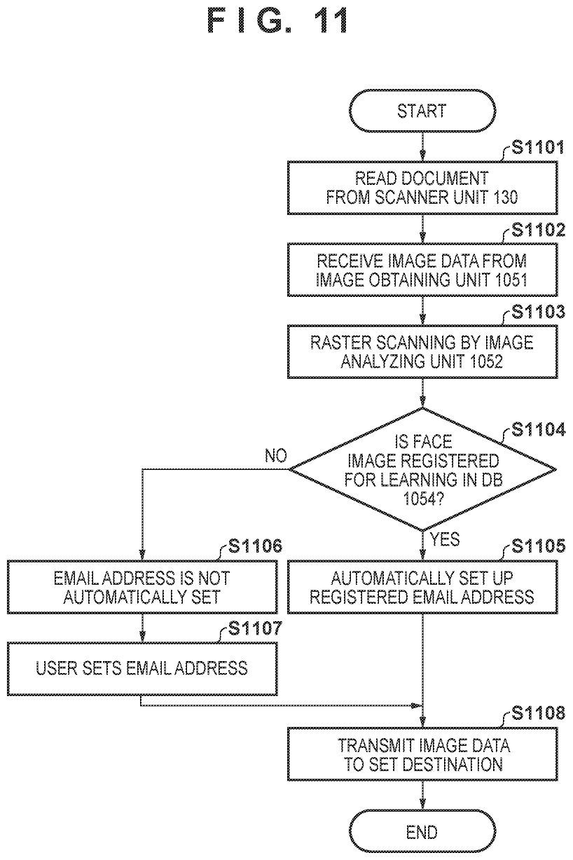

A sequence of processing for setting a destination when image data has been received using the send function, according to the present embodiment, will be described next with reference to FIG. 11. The processing described below is realized by, for example, the CPU 204 reading out a control program, stored in the ROM 103, the HDD 502, or the like in advance, into the RAM 104 and executing that program.

First, in step S1101, the CPU 204 causes a document such as a photograph to be read by the scanner unit 130, and image data is generated as a result. Then, in step S1102, the CPU 204 receives the generated image data through the image obtaining unit 1051 of the learning processing unit 105, and in step S1103, the image analyzing unit 1052 raster-scans the obtained image data.

Next, in step S1104, the CPU 204 uses the determining unit 1053 to determine whether or not there is a face image of an individual registered in the registration DB 1054. This determination is carried out through the above-described facial recognition and human specifying methods. If there is no face image of an individual, the sequence moves to step S1106, where the CPU 204 does not cause the output unit 1055 to output an email address; the automatic destination setting is not performed, and the sequence moves to step S1107. In step S1107, the CPU 204 sets the destination in response to user input, and the sequence then moves to step S1108.

On the other hand, if there is a face image of an individual registered in the registration DB 1054, the sequence moves to step S1105, where the CPU 204 causes the output unit 1055 to output the registered email address; that address is automatically set as the destination and displayed in the liquid-crystal operating panel 11, and the sequence then moves to step S1108. Here, even if the email address has been set automatically, the user can correct the destination as necessary by selecting the button 805 illustrated in FIG. 8.

Then, in step S1108, the CPU 204 transmits image data to the destination which has been set, in response to the user operating the start key 12. Although the send function has been described as an example here, the present invention is not intended to be limited thereto, and a similar function can be implemented when using the fax function as well, by employing telephone numbers instead of email addresses.

As described above, the information processing apparatus according to the present embodiment obtains image data, extracts a feature amount of a predetermined object included in the obtained image data, and based on the extracted feature amount, determines whether or not a specific object is included in an image expressed by the image data. Furthermore, if it is determined that the specific object is included in the image expressed by the image data, the information processing apparatus sets, as a transmission destination of the image data, contact information stored in association with the specific object stored in memory or the like in advance. Thus according to the present embodiment, when using a send function, a fax function, or the like, a feature amount is extracted from a read image using image recognition AI, the face of an individual having the same feature amount is specified, and a destination is set using contact information such as an email address with which the face has been associated and tagged. This makes it possible to eliminate the burden of the user setting the destination, which improves the convenience for the user.

Variations

Note that the present invention is not limited to the aforementioned embodiment, and many variations can be carried out thereon. For example, although an image forming apparatus is described as an example of the information processing apparatus in the present embodiment, the present invention can also be applied in a mobile terminal such as a smartphone. In this case, the present invention can be applied in a method in which a photograph shot by the mobile terminal such as a smartphone is selected, contact information is automatically set for an individual appearing in that photograph, and the photograph is transmitted.

Specifically, by the mobile terminal executing an application for managing/displaying image data such as photographs stored in the mobile terminal (a photo app), a plurality of photographs stored in the mobile terminal are displayed in a display unit, such as a touch panel, of the mobile terminal. Then, when the mobile terminal accepts the selection of a photograph (image) from among the plurality of photographs from the user, the selected image is displayed in an enlarged manner. Additionally, upon an image being selected by the user, the above-described image analysis processing and determination processing are executed for the selected image, and it is determined whether or not a face similar to the face of a human registered in advance in a DB of the mobile terminal has been detected in the image.

If a similar face has been detected, the mobile terminal displays an object (a pop-up or a notification) for selecting whether or not to transmit that image data to the transmission destination corresponding to the face stored in the DB. If a selection is made to transmit the image data, an object for allowing the user to select a transmission method is displayed. The transmission method can be selected from among email, P2P communication using Bluetooth (registered trademark), Wi-Fi, or the like, uploading to an SNS, and so on.

If “email” is selected, the selected image data is transmitted by email to the email address stored in association with the detected face of the person.

If “P2P communication” is selected, the mobile terminal searches for a nearby terminal. Specifically, it is determined whether an advertising packet from Bluetooth LE (Low Energy) or the like has been received. Terminal information (a name or the like of the terminal) is displayed in the mobile terminal based on the received advertising packet, and when the user selects that terminal information, the mobile terminal establishes a Bluetooth LE connection with the terminal corresponding to the selected terminal information. The image data may be transmitted through that Bluetooth LE communication, or may be handed over to a Wi-Fi Direct connection through that Bluetooth LE communication, and transmitted through Wi-Fi Direct communication.

Furthermore, the present invention can be applied in any information processing apparatus, as opposed to only image forming apparatuses, as long as the apparatus has a function for reading an image, using image recognition AI to determine the face of a person, automatically setting contact information, and transmitting data.

According to the present invention, when transmitting image data to the exterior, a transmission destination can be set in accordance with an image included in the image data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-163845 filed on Sep. 9, 2019, which is hereby incorporated by reference herein in its entirety.

What is claimed is:

1. An information processing apparatus comprising:
an obtaining unit that obtains image data;
an extracting unit that extracts a feature amount of a predetermined object included in the image data;
a determining unit that, based on the feature amount extracted by the extracting unit, determines whether a specific object is included in an image expressed by the image data; and
a destination setting unit that, in a case where the determining unit has determined that the specific object is included in the image expressed by the image data, sets, as a transmission destination of the image data, contact information stored in association with the specific object stored in a storage unit in advance.

2. The information processing apparatus according to claim 1, further comprising:
a user interface for transmitting the image data,
wherein the destination set by the destination setting unit is displayed in the user interface.

3. The information processing apparatus according to claim 2,
wherein the image expressed by the image data obtained by the obtaining unit is further displayed in the user interface.

4. The information processing apparatus according to claim 3,
wherein a button for displaying, in an enlarged manner, the specific object determined by the determining unit is displayed in the user interface in an operable state.

5. The information processing apparatus according to claim 2,
wherein the predetermined object is a face of a human; and
the determining unit determines whether or not the feature amount extracted by the extracting unit indicates a face of a human, and in a case where the feature amount indicates a face of a human, the determining unit compares the extracted feature amount with a feature amount of a specific human stored in advance in the storage unit, and in a case where the feature amounts are similar, the determining unit determines that the specific human is included in the image expressed by the image data.

6. The information processing apparatus according to claim 5,
wherein when the feature amount extracted by the extracting unit indicates a face of a human and does not resemble a feature amount of a specific human stored in advance in the storage unit, contact information of the human indicated by the feature amount extracted by the extracting unit can be input in the user interface.

7. The information processing apparatus according to claim 6, further comprising:
a learning unit that stores, in the storage unit, the contact information input through the user interface in association with the feature amount extracted by the extracting unit.

8. The information processing apparatus according to claim 1, further comprising:
a reading unit that reads a document and generates image data,
wherein the obtaining unit obtains the image data generated by the reading unit.

9. The information processing apparatus according to claim 1,
wherein the obtaining unit obtains image data from an external apparatus which can be communicated with over a network.

10. The information processing apparatus according to claim 1,
wherein the obtaining unit obtains the image data by reading image data stored in advance in the storage unit.

11. The information processing apparatus according to claim 1, further comprising:
a function setting unit that activates or deactivates a function of the destination setting unit for automatically setting the transmission destination of the image data.

12. The information processing apparatus according to claim 1,
wherein the feature amount includes a gradient histogram.

13. The information processing apparatus according to claim 1,
wherein the storage unit is provided in the information processing apparatus or in an external apparatus that can be accessed from the information processing apparatus.

14. A control method for an information processing apparatus, the method comprising:
obtaining image data;
extracting a feature amount of a predetermined object included in the image data;
determining, based on the feature amount extracted in the extracting,
whether a specific object is included in an image expressed by the image data; and
in a case where it has been determined in the determining that the specific object is included in the image expressed by the image data, setting, as a transmission destination of the image data, contact information stored in association with the specific object stored in a storage unit in advance.

15. A non-transitory computer-readable storage medium storing a program for causing a computer to execute each step of a control method for an information processing apparatus, the method comprising:
obtaining image data;
extracting a feature amount of a predetermined object included in the image data;
determining, based on the feature amount extracted in the extracting, whether a specific object is included in an image expressed by the image data; and
in a case where it has been determined in the determining that the specific object is included in the image expressed by the image data, setting, as a transmission destination of the image data, contact information stored in association with the specific object stored in a storage unit in advance.
